(19) United States
(12) Patent Application Publication
(10) Pub. No.: US 2014/0117916 A1
(43) Pub. Date: May 1, 2014

(54) VARIABLE SPEED ELECTRIC MOTOR CONTROLLER

(71) Applicant: Alexander John Richard, Furguson, IA (US)

(72) Inventor: Alexander John Richard, Furguson, IA (US)

(21) Appl. No.: 13/662,472

(22) Filed: Oct. 27, 2012

(51) Int. Cl. H02P 7/14; G05F 3/00

(52) U.S. Cl. 318/519; 323/203

(57) ABSTRACT

A variable speed electric motor controller includes a rotating cylinder having a variable amount of conductor material and a variable amount of insulator material along its length such that one side is mostly insulator and the other side is mostly conductor. An electrical connection, such as a brush, can contact the rotating cylinder and be moved therealong. A stationary electrical connector/brush can be permanently electrically connected to the conductor material. The flow of electricity from the movable brush to the stationary brush can be controlled by the speed of rotation of the shaft and the position of the movable brush therealong. The output can provide variable power to a load, such as an electric motor.

### BACKGROUND OF THE INVENTION

The present invention relates to motor controllers and, more particularly, to a variable speed electric motor controller.

Current motor controllers use electrical resistors and waste electricity. Such conventional motor controllers can become very expensive with high amperage. Moreover, such conventional motor controllers can are often large and bulky, taking up valuable space.

As can be seen, there is a need for an improved variable speed electric motor controller that is relatively inexpensive, creates little or no electricity waste and is compact in size compared to the wattage handled.

### SUMMARY OF THE INVENTION

In one aspect of the present invention, an electrical controller comprises a shaft; a cylinder disposed on the shaft, the cylinder having an electrically conductive portion of a cylinder outer surface; a non-conductive portion of the cylinder outer surface, wherein the amount of the non-conductive portion relative to the conductive portion about any given circumference of the cylinder varies from a first end to a second, opposite end thereof; a stationary electrical connection electrically connected to the electrically conductive portion of the cylinder; and a movable electrical connection movable along a length of the cylinder.

In another aspect of the present invention, a variable speed electric motor controller comprises a shaft; a motor operable to turn the shaft; a cylinder disposed on the shaft, the cylinder having an electrically conductive portion of a cylinder outer surface; a non-conductive portion of the cylinder outer surface, wherein the amount of the non-conductive portion relative to the conductive portion about any given circumference of the cylinder varies from a first end to a second, opposite end thereof; a stationary brush electrically connected to the electrically conductive portion of the cylinder; a movable brush movable along a length of the cylinder; and a power supply for providing power to the motor and to the movable electrical connection.

These and other features, aspects and advantages of the present invention will become better understood with reference to the following drawings, description and claims.

### BRIEF DESCRIPTION OF THE DRAWINGS

FIG. 1 is a perspective view of a variable speed electric motor controller according to an exemplary embodiment of the present invention; and

FIG. 2 is a side view of the variable speed electric motor controller of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a variable speed electric motor controller that includes a rotating cylinder having a variable amount of conductor material and a variable amount of insulator material along its length such that one side is mostly insulator and the other side is mostly conductor. An electrical connection, such as a brush, can contact the rotating cylinder and be moved therealong. A stationary electrical connector/brush can be permanently electrically connected to the conductor material. The flow of electricity from the movable brush to the stationary brush can be controlled by the speed of rotation of the shaft and the position of the movable brush therealong. The output can provide variable power to a load, such as an electric motor.

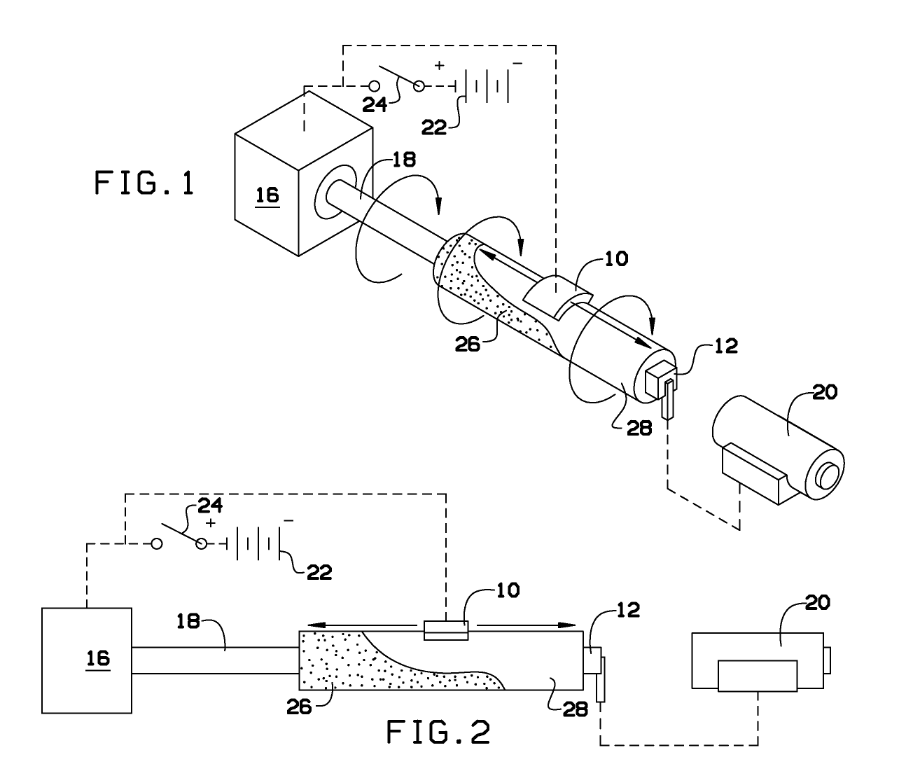

Referring now to FIGS. 1 and 2, a variable speed electric motor controller can include a shaft 18 that is operably turned by a motor 16. The motor 16 can be powered by a power supply 22 and controlled with a switch 24. The motor 16 can be a constant velocity motor that can turn the shaft 18 at a constant speed. The motor 16 can turn at a desired speed for the intended application.

A cylinder 28 can be disposed on the shaft 18. The cylinder 28 can have an electrically conductive outer housing, a portion 26 of which is non-conductive. The amount of this non-conductive portion 26 about an outer circumference of the cylinder 28 can vary from one end to the other end. A first end of the cylinder 28 can by formed almost completely of the non-conductive portion 26, while a second opposite end of the cylinder 28 can be formed almost completely of the conductive outer housing of the cylinder 28 with little or none of the non-conductive portion 26.

A stationary electrical connection, such as a stationary brush 12 can be electrically connected to the conductive outer housing of the cylinder 28. A movable electrical connection, such as a movable brush 10, can be operable to slide along the length of the cylinder 28. Various means can be used to move the movable brush 10, such as a servo motor (not shown) that can be operated under computer control.

Electricity can be configured to pass into the movable brush 12 and out of the stationary brush 14 to supply power to a load, such as a variable speed motor 20. As the cylinder 28 rotates, the position of the movable brush 12 along the cylinder 28 determines how much power passes through to the stationary brush 14. The system of the present invention can control the output power like a pulse width modulator, where the pulse width is controlled by the position of the movable brush 12 along the cylinder 28 and the frequency of the pulses are determined by the speed of the motor 16.

The system of the present invention can be used in various applications, fields and industries where the regulation of electricity is desired. For example, the system of the present invention could be used in hybrid or electric vehicles.

While the above described powering a variable speed motor with the controller of the present invention, such a controller can find application in other industries and applications.

It should be understood, of course, that the foregoing relates to exemplary embodiments of the invention and that modifications may be made without departing from the spirit and scope of the invention as set forth in the following claims.

What is claimed is:

1. An electrical controller comprising:
a shaft;
a cylinder disposed on the shaft, the cylinder having an electrically conductive portion of a cylinder outer surface;
a non-conductive portion of the cylinder outer surface, wherein the amount of the non-conductive portion relative to the conductive portion about any given circumference of the cylinder varies from a first end to a second, opposite end thereof;
a stationary electrical connection electrically connected to the electrically conductive portion of the cylinder; and
a movable electrical connection movable along a length of the cylinder.

2. The electrical controller of claim 1, further comprising a motor for rotating the shaft.

3. The electrical controller of claim 2, wherein the motor is a constant speed motor.

4. The electrical controller of claim 2, further comprising a power supply for providing power to the motor and to the movable electrical connection.

5. The electrical controller of claim 1, wherein the stationary electrical connection is a stationary brush.

6. The electrical controller of claim 1, wherein the movable electrical connection is a movable brush.

7. The electrical controller of claim 1, further comprising a load connected to an output of the stationary electrical connection.

8. The electrical controller of claim 7, wherein the load is a variable speed motor.

9. The electrical controller of claim 4, further comprising a switch to connect and disconnect the power supply from the motor and the movable electrical connection.

10. The electrical controller of claim 1, wherein the first end of the cylinder is formed almost completely of the non-conductive portion and the second opposite end of the cylinder is formed almost completely of the conductive portion.

11. A variable speed electric motor controller comprising:
a shaft;
a motor operable to turn the shaft;
a cylinder disposed on the shaft, the cylinder having an electrically conductive portion of a cylinder outer surface;
a non-conductive portion of the cylinder outer surface, wherein the amount of the non-conductive portion relative to the conductive portion about any given circumference of the cylinder varies from a first end to a second, opposite end thereof;
a stationary brush electrically connected to the electrically conductive portion of the cylinder;
a movable brush movable along a length of the cylinder; and
a power supply for providing power to the motor and to the movable electrical connection.

12. The electrical controller of claim 11, wherein the motor is a constant speed motor.

13. The electrical controller of claim 11, wherein the first end of the cylinder is formed almost completely of the non-conductive portion and the second opposite end of the cylinder is formed almost completely of the conductive portion.
